(19) United States
(12) Patent Application Publication
(10) Pub. No.: US 2024/0259388 A1
(43) Pub. Date: Aug. 1, 2024

(54) MULTI-TENANCY AUTHORIZATION FRAMEWORK FOR HIERARCHICAL RESOURCES OF A DATA MANAGEMENT SYSTEM

(71) Applicant: Rubrik, Inc., Palo Alto, CA (US)

(72) Inventors: Hao Wu, Mountain View, CA (US); Sai Tanay Desaraju, Redwood City, CA (US); Kevin Mu, Saratoga, CA (US); Xiang Xu, Foster City, CA (US); Lokesh Jagasia, Union City, CA (US); Zhebin Zhang, San Jose, CA (US); Shrihari Kalkar, Santa Clara, CA (US); Anam Bhatia, San Jose, CA (US); Michael Wronski, Johns Creek, GA (US); Arvind Swaminathan, Palo Alto, CA (US)

(21) Appl. No.: 18/187,188

(22) Filed: Mar. 21, 2023

(30) Foreign Application Priority Data
Jan. 27, 2023 (IN) 202341005512

(51) Int. Cl. H04L 9/40

(52) U.S. Cl. CPC H04L 63/105; H04L 63/102; H04L 63/104

(57) ABSTRACT

Methods, systems, and devices for data management are described. A data management system (DMS) may implement multi-tenancy role based access control (RBAC). A DMS that provides backup and recovery to multiple tenants may assign a data management cluster to a tenant organization, or specific resources from a data management cluster to a tenant, allowing multiple tenants to share a single data management cluster. The assignment of resources of the data management cluster respects the hierarchical relationship among computing objects, for example, assigning a top-level resource to a tenant implicitly assigns the descendent resources that descend from that top-level resource to the tenant.

### RELATED APPLICATIONS

The present application claims priority to Indian Patent Application No. 202341005512, entitled “MULTI-TENANCY AUTHORIZATION FRAMEWORK FOR HIERARCHICAL RESOURCES OF A DATA MANAGEMENT SYSTEM” and filed Jan. 27, 2023, which is assigned to the assignee hereof and expressly incorporated by reference herein.

### FIELD OF TECHNOLOGY

The present disclosure relates generally to data management, including techniques for multi-tenancy authorization framework for hierarchical resources of a data management system.

### BACKGROUND

A data management system (DMS) may be employed to manage data associated with one or more computing systems. The data may be generated, stored, or otherwise used by the one or more computing systems, examples of which may include servers, databases, virtual machines, cloud computing systems, file systems (e.g., network-attached storage (NAS) systems), or other data storage or processing systems. The DMS may provide data backup, data recovery, data classification, or other types of data management services for data of the one or more computing systems. Improved data management may offer improved performance with respect to reliability, speed, efficiency, scalability, security, or ease-of-use, among other possible aspects of performance.

### BRIEF DESCRIPTION OF THE DRAWINGS

FIG. 1 illustrates an example of a computing environment that supports multi-tenancy authorization framework for hierarchical resources of a data management system in accordance with aspects of the present disclosure.

FIG. 2 illustrates an example of a multi-tenancy system that supports multi-tenancy authorization framework for hierarchical resources of a data management system in accordance with aspects of the present disclosure.

FIG. 3 illustrates an example of a computing object hierarchy that supports multi-tenancy authorization framework for hierarchical resources of a data management system in accordance with aspects of the present disclosure.

FIG. 4 illustrates an example of a user interface view that supports multi-tenancy authorization framework for hierarchical resources of a data management system in accordance with aspects of the present disclosure.

FIG. 5 illustrates an example of a process flow that supports multi-tenancy authorization framework for hierarchical resources of a data management system in accordance with aspects of the present disclosure.

FIG. 6 illustrates a block diagram of an apparatus that supports multi-tenancy authorization framework for hierarchical resources of a data management system in accordance with aspects of the present disclosure.

FIG. 7 illustrates a block diagram of a data management system that supports multi-tenancy authorization framework for hierarchical resources of a data management system in accordance with aspects of the present disclosure.

FIG. 8 illustrates a diagram of a system including a device that supports multi-tenancy authorization framework for hierarchical resources of a data management system in accordance with aspects of the present disclosure.

FIGS. 9 and 10 illustrate flowcharts showing methods that support multi-tenancy authorization framework for hierarchical resources of a data management system in accordance with aspects of the present disclosure.

### DETAILED DESCRIPTION

Some backup and recovery systems use role-based access control (RBAC) to manage which users or administrators can change aspects of the system configuration, such as changing encryption settings or modifying/deleting files from a database. RBAC generally refers to the process of assigning permissions to different users of a backup and recovery system. For example, a first user may have permission to update service level agreement (SLA) settings of a first database, while a second user may have permission to configure network settings for a second database. In some cases, these permissions may be assigned, removed, or modified by a system administrator. RBAC schemes may reduce the likelihood of users accidentally (or maliciously) making changes to a backup and recovery system.

A multi-tenancy data management system may have resources across cloud platforms and on-premise data centers. In multi-tenant scenarios, multiple tenants (e.g., organizations or business units) may share data management resources. Further, some multi-tenant scenarios may be multi-level, with multiple hierarchical levels of tenants. For example, resources of a backup and recovery system may be shared among multiple higher-level tenants, and at least some of the higher-level tenants may be associated with one or more levels of lower-level tenants (e.g., subtenants), with resources associated with a higher-level tenant being shared by multiple subtenants of that tenant.

As one such example, which may be referred to as an enterprise scenario, an information technology (IT) services unit of a business (e.g., of a corporation) may be a tenant of a data management system, and multiple other business units of the same business (e.g., within the same corporation) may be subtenants of the IT services unit, and accordingly, may share the same data management services. As another such example, some tenants of a data management system may be multi-service providers (MSPs). An MSP may be a higher-level tenant of a backup and recovery system and may provide IT and data management services to multiple distinct customers, which may be separate businesses that are subtenants of the MSPs. For example, the MSP may subscribe to data management services and resources from the data management system, and the MSP may use those services and resources to in turn provide data management service to the MSP's subtenants (e.g., an MSP subtenant may not directly subscribe to the data management system, such as due to a lack of internal expertise in configuring or managing the resources or services of the data management system, and thus the MSP subtenant may instead be customer of the MSP, which may directly subscribe to the data management system and use the MSP's subscription to offer data management services to the MSP subtenant).

There may be many tenants of the data management system, and some or all of the tenants may have any number of subtenants. The tenants of the data management system may be enterprise tenants, MSP tenants, other types of entities, or any combination thereof. Further, an entity that is a subtenant of a higher-level tenant may itself have one or more subtenants. That is, there may be three or more levels of tenants—in general, any quantity of levels may exist.

Aspects of the present disclosure relate to the object-level assignment of resources of a data management system to given tenant organizations. For example, an MSP with multiple tenants may assign a data management cluster to a tenant organization, or specific resources from a data management cluster to a tenant organization, allowing multiple tenants to share a single data management cluster. As another example, an IT services unit for an organization may assign a data management cluster to a business unit of the organization, or the IT services unit may assign specific resources from a data management cluster to a particular business unit, allowing business units of an organization to share a single data management cluster. The assignment of resources respects the hierarchical relationship among computing objects, for example, assigning a top-level resource to a tenant implicitly assigns the descendent resources that descend from that top-level resource to the tenant. Multi-tenant RBAC supports in-depth RBAC enforcement. For example, a tenant may not view either direct or aggregated information about objects that are not assigned and/or authorized for that tenant. Multi-tenant RBAC may enable different permissions on different objects. For example, a tenant may be given read-only access to a given virtual machine, but may be given read/write access to a MSSQL database.

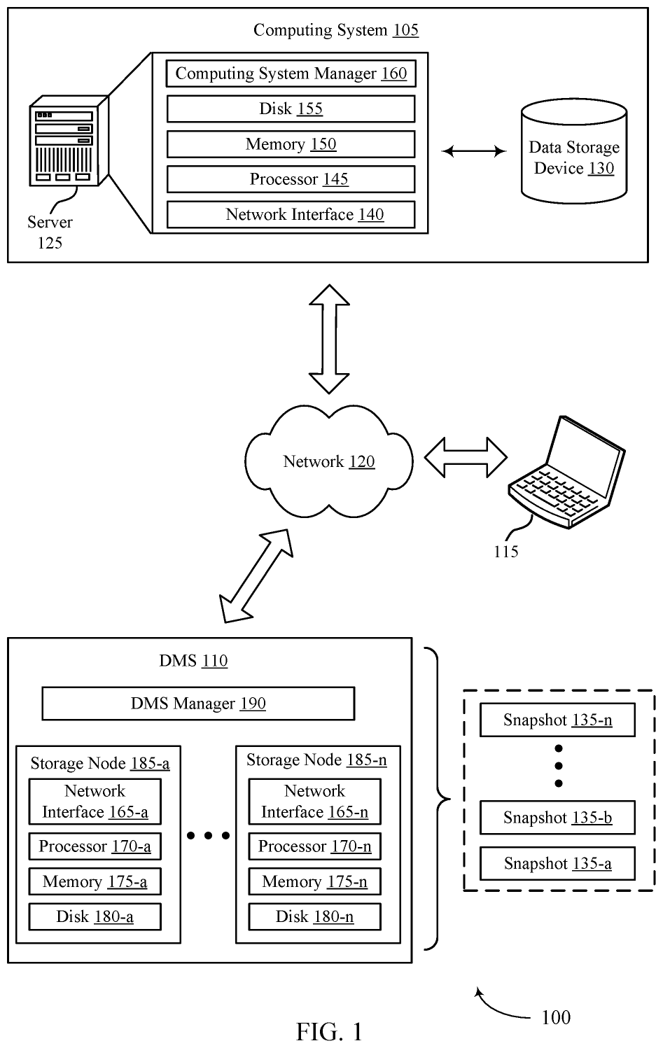

FIG. 1 illustrates an example of a computing environment 100 that supports multi-tenancy authorization framework for hierarchical resources of a data management system in accordance with aspects of the present disclosure. The computing environment 100 may include a computing system 105, a data management system (DMS) 110, and one or more computing devices 115, which may be in communication with one another via a network 120. The computing system 105 may generate, store, process, modify, or otherwise use associated data, and the DMS 110 may provide one or more data management services for the computing system 105. For example, the DMS 110 may provide a data backup service, a data recovery service, a data classification service, a data transfer or replication service, one or more other data management services, or any combination thereof for data associated with the computing system 105.

The network 120 may allow the one or more computing devices 115, the computing system 105, and the DMS 110 to communicate (e.g., exchange information) with one another. The network 120 may include aspects of one or more wired networks (e.g., the Internet), one or more wireless networks (e.g., cellular networks), or any combination thereof. The network 120 may include aspects of one or more public networks or private networks, as well as secured or unsecured networks, or any combination thereof. The network 120 also may include any quantity of communications links and any quantity of hubs, bridges, routers, switches, ports or other physical or logical network components.

A computing device 115 may be used to input information to or receive information from the computing system 105, the DMS 110, or both. For example, a user of the computing device 115 may provide user inputs via the computing device 115, which may result in commands, data, or any combination thereof being communicated via the network 120 to the computing system 105, the DMS 110, or both. Additionally, or alternatively, a computing device 115 may output (e.g., display) data or other information received from the computing system 105, the DMS 110, or both. A user of a computing device 115 may, for example, use the computing device 115 to interact with one or more user interfaces (e.g., graphical user interfaces (GUIs)) to operate or otherwise interact with the computing system 105, the DMS 110, or both. Though one computing device 115 is shown in FIG. 1, it is to be understood that the computing environment 100 may include any quantity of computing devices 115.

A computing device 115 may be a stationary device (e.g., a desktop computer or access point) or a mobile device (e.g., a laptop computer, tablet computer, or cellular phone). In some examples, a computing device 115 may be a commercial computing device, such as a server or collection of servers. And in some examples, a computing device 115 may be a virtual device (e.g., a virtual machine). Though shown as a separate device in the example computing environment of FIG. 1, it is to be understood that in some cases a computing device 115 may be included in (e.g., may be a component of) the computing system 105 or the DMS 110.

The computing system 105 may include one or more servers 125 and may provide (e.g., to the one or more computing devices 115) local or remote access to applications, databases, or files stored within the computing system 105. The computing system 105 may further include one or more data storage devices 130. Though one server 125 and one data storage device 130 are shown in FIG. 1, it is to be understood that the computing system 105 may include any quantity of servers 125 and any quantity of data storage devices 130, which may be in communication with one another and collectively perform one or more functions ascribed herein to the server 125 and data storage device 130.

A data storage device 130 may include one or more hardware storage devices operable to store data, such as one or more hard disk drives (HDDs), magnetic tape drives, solid-state drives (SSDs), storage area network (SAN) storage devices, or network-attached storage (NAS) devices. In some cases, a data storage device 130 may comprise a tiered data storage infrastructure (or a portion of a tiered data storage infrastructure). A tiered data storage infrastructure may allow for the movement of data across different tiers of the data storage infrastructure between higher-cost, higher-performance storage devices (e.g., SSDs and HDDs) and relatively lower-cost, lower-performance storage devices (e.g., magnetic tape drives). In some examples, a data storage device 130 may be a database (e.g., a relational database), and a server 125 may host (e.g., provide a database management system for) the database.

A server 125 may allow a client (e.g., a computing device 115) to download information or files (e.g., executable, text, application, audio, image, or video files) from the computing system 105, to upload such information or files to the computing system 105, or to perform a search query related to particular information stored by the computing system 105. In some examples, a server 125 may act as an application server or a file server. In general, a server 125 may refer to one or more hardware devices that act as the host in a client-server relationship or a software process that shares a resource with or performs work for one or more clients.

A server 125 may include a network interface 140, processor 145, memory 150, disk 155, and computing system manager 160. The network interface 140 may enable the server 125 to connect to and exchange information via the network 120 (e.g., using one or more network protocols). The network interface 140 may include one or more wireless network interfaces, one or more wired network interfaces, or any combination thereof. The processor 145 may execute computer-readable instructions stored in the memory 150 in order to cause the server 125 to perform functions ascribed herein to the server 125. The processor 145 may include one or more processing units, such as one or more central processing units (CPUs), one or more graphics processing units (GPUs), or any combination thereof. The memory 150 may comprise one or more types of memory (e.g., random access memory (RAM), static random access memory (SRAM), dynamic random access memory (DRAM), read-only memory ((ROM), electrically erasable programmable read-only memory (EEPROM), Flash, etc.). Disk 155 may include one or more HDDs, one or more SSDs, or any combination thereof. Memory 150 and disk 155 may comprise hardware storage devices. The computing system manager 160 may manage the computing system 105 or aspects thereof (e.g., based on instructions stored in the memory 150 and executed by the processor 145) to perform functions ascribed herein to the computing system 105. In some examples, the network interface 140, processor 145, memory 150, and disk 155 may be included in a hardware layer of a server 125, and the computing system manager 160 may be included in a software layer of the server 125. In some cases, the computing system manager 160 may be distributed across (e.g., implemented by) multiple servers 125 within the computing system 105.

In some examples, the computing system 105 or aspects thereof may be implemented within one or more cloud computing environments, which may alternatively be referred to as cloud environments. Cloud computing may refer to Internet-based computing, wherein shared resources, software, and/or information may be provided to one or more computing devices on-demand via the Internet. A cloud environment may be provided by a cloud platform, where the cloud platform may include physical hardware components (e.g., servers) and software components (e.g., operating system) that implement the cloud environment. A cloud environment may implement the computing system 105 or aspects thereof through Software-as-a-Service (SaaS) or Infrastructure-as-a-Service (IaaS) services provided by the cloud environment. SaaS may refer to a software distribution model in which applications are hosted by a service provider and made available to one or more client devices over a network (e.g., to one or more computing devices 115 over the network 120). IaaS may refer to a service in which physical computing resources are used to instantiate one or more virtual machines, the resources of which are made available to one or more client devices over a network (e.g., to one or more computing devices 115 over the network 120).

In some examples, the computing system 105 or aspects thereof may implement or be implemented by one or more virtual machines. The one or more virtual machines may run various applications, such as a database server, an application server, or a web server. For example, a server 125 may be used to host (e.g., create, manage) one or more virtual machines, and the computing system manager 160 may manage a virtualized infrastructure within the computing system 105 and perform management operations associated with the virtualized infrastructure. The computing system manager 160 may manage the provisioning of virtual machines running within the virtualized infrastructure and provide an interface to a computing device 115 interacting with the virtualized infrastructure. For example, the computing system manager 160 may be or include a hypervisor and may perform various virtual machine-related tasks, such as cloning virtual machines, creating new virtual machines, monitoring the state of virtual machines, moving virtual machines between physical hosts for load balancing purposes, and facilitating backups of virtual machines. In some examples, the virtual machines, the hypervisor, or both, may virtualize and make available resources of the disk 155, the memory, the processor 145, the network interface 140, the data storage device 130, or any combination thereof in support of running the various applications. Storage resources (e.g., the disk 155, the memory 150, or the data storage device 130) that are virtualized may be accessed by applications as a virtual disk.

The DMS 110 may provide one or more data management services for data associated with the computing system 105 and may include DMS manager 190 and any quantity of storage nodes 185. The DMS manager 190 may manage operation of the DMS 110, including the storage nodes 185. Though illustrated as a separate entity within the DMS 110, the DMS manager 190 may in some cases be implemented (e.g., as a software application) by one or more of the storage nodes 185. In some examples, the storage nodes 185 may be included in a hardware layer of the DMS 110, and the DMS manager 190 may be included in a software layer of the DMS 110. In the example illustrated in FIG. 1, the DMS 110 is separate from the computing system 105 but in communication with the computing system 105 via the network 120. It is to be understood, however, that in some examples at least some aspects of the DMS 110 may be located within computing system 105. For example, one or more servers 125, one or more data storage devices 130, and at least some aspects of the DMS 110 may be implemented within the same cloud environment or within the same data center.

Storage nodes 185 of the DMS 110 may include respective network interfaces 165, processors 170, memories 175, and disks 180. The network interfaces 165 may enable the storage nodes 185 to connect to one another, to the network 120, or both. A network interface 165 may include one or more wireless network interfaces, one or more wired network interfaces, or any combination thereof. The processor 170 of a storage node 185 may execute computer-readable instructions stored in the memory 175 of the storage node 185 in order to cause the storage node 185 to perform processes described herein as performed by the storage node 185. A processor 170 may include one or more processing units, such as one or more CPUs, one or more GPUs, or any combination thereof. The memory 150 may comprise one or more types of memory (e.g., RAM, SRAM, DRAM, ROM, EEPROM, Flash, etc.). A disk 180 may include one or more HDDs, one or more SDDs, or any combination thereof. Memories 175 and disks 180 may comprise hardware storage devices. Collectively, the storage nodes 185 may in some cases be referred to as a storage cluster or as a cluster of storage nodes 185.

The DMS 110 may provide a backup and recovery service for the computing system 105. For example, the DMS 110 may manage the extraction and storage of snapshots 135 associated with different point-in-time versions of one or more target data sources within the computing system 105. A snapshot 135 of a computing object (e.g., a virtual machine, a database, a filesystem, a virtual disk, a virtual desktop, or other type of computing system or storage system) may be a file (or set of files) that represents a state of the computing object (e.g., the data thereof) as of a particular point in time. A snapshot 135 may also be used to restore (e.g., recover) the corresponding computing object as of the particular point in time corresponding to the snapshot 135. A computing object of which a snapshot 135 may be generated may be referred to as snappable. Snapshots 135 may be generated at different times (e.g., periodically or on some other scheduled or configured basis) in order to represent the state of the computing system 105 or aspects thereof as of those different times. In some examples, a snapshot 135 may include metadata that defines a state of the computing object as of a particular point in time. For example, a snapshot 135 may include metadata associated with (e.g., that defines a state of) some or all data blocks included in (e.g., stored by or otherwise included in) the computing object. Snapshots 135 (e.g., collectively) may capture changes in the data blocks over time. Snapshots 135 generated for the target data sources within the computing system 105 may be stored in one or more storage locations (e.g., the disk 155, memory 150, the data storage device 130) of the computing system 105, in the alternative or in addition to being stored within the DMS 110, as described below.

To obtain a snapshot 135 of a target computing object associated with the computing system 105 (e.g., of the entirety of the computing system 105 or some portion thereof, such as one or more databases, virtual machines, or filesystems within the computing system 105), the DMS manager 190 may transmit a snapshot request to the computing system manager 160. In response to the snapshot request, the computing system manager 160 may set the target computing object into a frozen state (e.g., a read-only state). Setting the target computing object into a frozen state may allow a point-in-time snapshot 135 of the target computing object to be stored or transferred.

In some examples, the computing system 105 may generate the snapshot 135 based on the frozen state of the computing object. For example, the computing system 105 may execute an agent of the DMS 110 (e.g., the agent may be software installed at and executed by one or more servers 125), and the agent may cause the computing system 105 to generate the snapshot 135 and transfer the snapshot to the DMS 110 in response to the request from the DMS 110. In some examples, the computing system manager 160 may cause the computing system 105 to transfer, to the DMS 110, data that represents the frozen state of the target computing object, and the DMS 110 may generate a snapshot 135 of the target computing object based on the corresponding data received from the computing system 105.

Once the DMS 110 receives, generates, or otherwise obtains a snapshot 135, the DMS 110 may store the snapshot 135 at one or more of the storage nodes 185. The DMS 110 may store a snapshot 135 at multiple storage nodes 185, for example, for improved reliability. Additionally, or alternatively, snapshots 135 may be stored in some other location connected with the network 120. For example, the DMS 110 may store more recent snapshots 135 at the storage nodes 185, and the DMS 110 may transfer less recent snapshots 135 via the network 120 to a cloud environment (which may include or be separate from the computing system 105) for storage at the cloud environment, a magnetic tape storage device, or another storage system separate from the DMS 110.

Updates made to a target computing object that has been set into a frozen state may be written by the computing system 105 to a separate file (e.g., an update file) or other entity within the computing system 105 while the target computing object is in the frozen state. After the snapshot 135 (or associated data) of the target computing object has been transferred to the DMS 110, the computing system manager 160 may release the target computing object from the frozen state, and any corresponding updates written to the separate file or other entity may be merged into the target computing object.

In response to a restore command (e.g., from a computing device 115 or the computing system 105), the DMS 110 may restore a target version (e.g., corresponding to a particular point in time) of a computing object based on a corresponding snapshot 135 of the computing object. In some examples, the corresponding snapshot 135 may be used to restore the target version based on data of the computing object as stored at the computing system 105 (e.g., based on information included in the corresponding snapshot 135 and other information stored at the computing system 105, the computing object may be restored to its state as of the particular point in time). Additionally, or alternatively, the corresponding snapshot 135 may be used to restore the data of the target version based on data of the computing object as included in one or more backup copies of the computing object (e.g., file-level backup copies or image-level backup copies). Such backup copies of the computing object may be generated in conjunction with or according to a separate schedule than the snapshots 135. For example, the target version of the computing object may be restored based on the information in a snapshot 135 and based on information included in a backup copy of the target object generated prior to the time corresponding to the target version. Backup copies of the computing object may be stored at the DMS 110 (e.g., in the storage nodes 185) or in some other location connected with the network 120 (e.g., in a cloud environment, which in some cases may be separate from the computing system 105).

In some examples, the DMS 110 may restore the target version of the computing object and transfer the data of the restored computing object to the computing system 105. And in some examples, the DMS 110 may transfer one or more snapshots 135 to the computing system 105, and restoration of the target version of the computing object may occur at the computing system 105 (e.g., as managed by an agent of the DMS 110, where the agent may be installed and operate at the computing system 105).

In response to a mount command (e.g., from a computing device 115 or the computing system 105), the DMS 110 may instantiate data associated with a point-in-time version of a computing object based on a snapshot 135 corresponding to the computing object (e.g., along with data included in a backup copy of the computing object) and the point-in-time. The DMS 110 may then allow the computing system 105 to read or modify the instantiated data (e.g., without transferring the instantiated data to the computing system). In some examples, the DMS 110 may instantiate (e.g., virtually mount) some or all of the data associated with the point-in-time version of the computing object for access by the computing system 105, the DMS 110, or the computing device 115.

In some examples, the DMS 110 may store different types of snapshots, including for the same computing object. For example, the DMS 110 may store both base snapshots 135 and incremental snapshots 135. A base snapshot 135 may represent the entirety of the state of the corresponding computing object as of a point in time corresponding to the base snapshot 135. An incremental snapshot 135 may represent the changes to the state—which may be referred to as the delta—of the corresponding computing object that have occurred between an earlier or later point in time corresponding to another snapshot 135 (e.g., another base snapshot 135 or incremental snapshot 135) of the computing object and the incremental snapshot 135. In some cases, some incremental snapshots 135 may be forward-incremental snapshots 135 and other incremental snapshots 135 may be reverse-incremental snapshots 135. To generate a full snapshot 135 of a computing object using a forward-incremental snapshot 135, the information of the forward-incremental snapshot 135 may be combined with (e.g., applied to) the information of an earlier base snapshot 135 of the computing object along with the information of any intervening forward-incremental snapshots 135, where the earlier base snapshot 135 may include a base snapshot 135 and one or more reverse-incremental or forward-incremental snapshots 135. To generate a full snapshot 135 of a computing object using a reverse-incremental snapshot 135, the information of the reverse-incremental snapshot 135 may be combined with (e.g., applied to) the information of a later base snapshot 135 of the computing object along with the information of any intervening reverse-incremental snapshots 135.

In some examples, the DMS 110 may provide a data classification service, a malware detection service, a data transfer or replication service, backup verification service, or any combination thereof, among other possible data management services for data associated with the computing system 105. For example, the DMS 110 may analyze data included in one or more data sources of the computing system 105, metadata for one or more data sources of the computing system 105, or any combination thereof, and based on such analysis, the DMS 110 may identify locations within the computing system 105 that include data of one or more target data types (e.g., sensitive data, such as data subject to privacy regulations or otherwise of particular interest) and output related information (e.g., for display to a user via a computing device 115). Additionally, or alternatively, the DMS 110 may detect whether aspects of the computing system 105 have been impacted by malware (e.g., ransomware). Additionally, or alternatively, the DMS 110 may relocate data or create copies of data based on using one or more snapshots 135 to restore the associated computing object within its original location or at a new location (e.g., a new location within a different computing system 105). Additionally, or alternatively, the DMS 110 may analyze backup data to ensure that the underlying data (e.g., user data or metadata) has not been corrupted. The DMS 110 may perform such data classification, malware detection, data transfer or replication, or backup verification, for example, based on data included in snapshots 135 or backup copies of the computing system 105, rather than live contents of the computing system 105, which may beneficially avoid adversely affecting (e.g., infecting, loading, etc.) the computing system 105.

In some aspects, the DMS 110 may provide backup and recovery protection for data sources for multiple tenants. For example, multiple tenants may share data management resources (e.g., computing objects) of the DMS 110, such as the DMS manager 190 and the storage nodes 185. Further, some multi-tenant scenarios may be multi-level, with multiple hierarchical levels of tenants. For example, resources of a backup and recovery system may be shared among multiple higher-level tenants, and at least some of the higher-level tenants may be associated with one or more levels of lower-level tenants (e.g., subtenants), with resources associated with a higher-level tenant being shared by multiple subtenants of that tenant. As one such example, in an enterprise scenario, multiple business units of the same enterprise may be subtenants of the same IT services unit, and accordingly, may share the same DMS 110, with the IT services unit being one of multiple higher-level tenants of a backup and recovery system and the other business units of the same enterprise being subtenants of the IT services unit. As another such example, some MSPs may be higher-level tenants of the DMS 110 and may provide IT and data management services to multiple distinct customers (e.g., different subtenants of the MSPs).

The DMS 110 may implement RBAC schemes among the different tenants that share the DMS 110. Further, object-level assignment of resources of the DMS 110 may respect a resource hierarchy of the DMS 110. For example, an MSP with multiple tenants may assign a data management cluster of the DMS 110 to a tenant organization, or specific resources from a data management cluster of the DMS 110 to a tenant, allowing multiple tenants to share a single data management cluster. As another example, an IT services unit for an organization may assign a data management cluster of the DMS 110 to a business unit of the organization, or the IT services unit may assign specific resources from a data management cluster to a particular business unit, allowing business units of an organization to share a single data management cluster of the DMS 110. The assignment of resources respects the hierarchical relationship among computing objects, for example, assigning a top-level resource to a tenant implicitly assigns the descendent resources that descend from that top-level resource to the tenant. Multi-tenant RBAC supports in-depth RBAC enforcement. For example, a tenant may not view (e.g., via a tenant user interface view at a computing device 115) either direct or aggregated information about objects that are not assigned and/or authorized for that tenant. Multi-tenant RBAC may enable different permissions on different objects. For example, a tenant may be given read-only access to a given virtual machine, but may be given read/write access to a MSSQL database. An administrator account (e.g., via an administrator user interface views at a computing device 115) may assign one or more computing objects of the DMS 110 to a given tenant, and such an assignment may involve the assignment of other computing objects of the DMS 110 in a hierarchical relationship with the one or more assigned computing objects of the DMS 110.

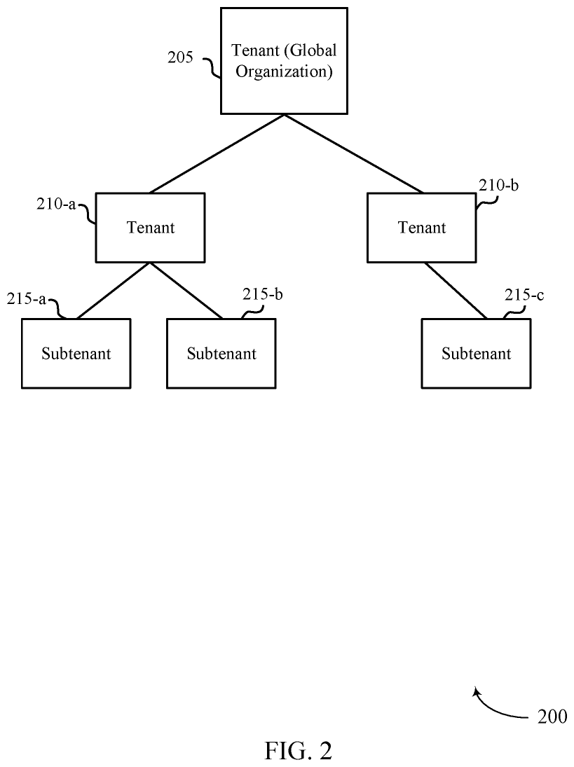

FIG. 2 illustrates an example of a multi-tenancy system 200 that supports multi-tenancy authorization framework for hierarchical resources of a data management system in accordance with aspects of the present disclosure. The multi-tenancy system 200 may implement or be implemented by aspects of the computing environment 100 described with reference to FIG. 1. For example, a DMS 110 may provide backup and recovery protection for data sources for multiple tenants and/or subtenants.

As described herein, a global organization (e.g., a tenant 205) may provide IT services, including backup and recovery protection via a DMS 110, to multiple tenants (e.g., tenant 210-a and tenant 210-b). Additionally, each tenant may further have subtenants. For example, the tenant 210-a may have a subtenant 215-a and a subtenant 215-b. For example, the tenant 205 may be the IT services unit of an organization, and the tenant 210-a and the tenant 210-b may be business units of or teams within the organization. The subtenant 215-a and the subtenant 215-b may be sub-business units or sub-teams of the business unit corresponding to the tenant 210-a (e.g., working groups within the business unit). The subtenant 215-c similarly may be a sub-business unit or sub-team of the business unit corresponding to the tenant 210-b. As another example, the tenant 205 may be an MSP, and the tenant 210-a and the tenant 210-b may be different enterprises/customers (e.g., organizations) of the MSP. The subtenant 215-a, the subtenant 215-b, and the subtenant 215-c may be business units and/or working groups/entities of the enterprises/customers/teams corresponding to the tenant 210-a and the tenant 210-b.

In some examples, the tenant 205 corresponds to a DMS 110 that controls backup and recovery resources that are used to provide backup and recovery protection to the various tenants 210-a and sub-tenants 215 of the organization. An administrative user of the tenant 205 may access the DMS 110 to configure and allocate resources (e.g., computing objects) that are used to support backup and recovery for data sources associated with the various tenants and subtenants. For example, the user may access a user interface of the DMS 110 to create the tenants 210-a and 210-b and to assign the respective backup and recovery resources to the created tenants 210-a and 210-b. Assignment of resources to a tenant may include updating metadata (e.g., RBAC metadata) associated with the respective resources to indicate respective tenant or subtenant assignments. In some cases, the administrative user may assign, to a tenant or subtenant using the user interface of the DMS 110, a data source that is to be backed-up using a respective resource, a backup or recovery procedure that may be performed using the respective resource, and/or a storage capacity for the backup and recovery resource. Assignment of a data source, procedure, or capacity may include updating the metadata (e.g., RBAC metadata) associated with the backup and recovery resource (e.g., computing object) that is to be used by the tenant or subtenant.

In some cases, the administrative user may access the user interface of the DMS 110 to assign users to the tenants 210 or subtenants 215. For example, the administrative user of the tenant 205 may assign a second administrative user to the tenant 210-a such that the second administrative user may access the platform for backup and recovery management, as well as further subtenant creation and resource assignment, data source assignment, procedure assignment, and capacity assignment. A third demonstrative user may be similarly assigned to the tenant 210-b. User assignment may be restricted or controlled based on hierarchical techniques, as described herein with respect to computing object assignment.

As described herein, users may access a user interface associated with the DMS 110 to control various backup and recovery aspects related to a tenant 205 or 210 or subtenant 215. In some examples, the user interface may be supported by a platform or application that is used to manage multiple DMSs 110, multiple tenants 205, subtenants 215, etc. In some examples, an authorized user may access the platform or application to control backup and recovery procedures, as well as tenant or subtenant creation and assignment. Each tenant 205 or 210 or subtenant 215 may be associated with a “context” of the platform or application. An application context refers to a state of an application that allows a user to manage to control aspects of backup and recovery associated with a particular tenant 205 or 210 or subtenant 215. Thus, a user may access an application context associated with the tenant 210-a and the user may view resources, procedures, etc. that are assigned to the tenant 210-a as well as create subtenants of the tenant 210-a (e.g., subtenants 215-a and 215-b) and assign subsets of resources to the created subtenants. Thus, when discussing a user accessing a user interface of the DMS 110 herein, the user may access the application context associated with a tenant or subtenant to perform various functions and procedures described herein.

As described herein, the DMS 110 may provide for an RBAC scheme such that users associated with each tenant/subtenant may access only the computing objects assigned to the given tenant/subtenant. Accordingly, the tenants 210 and subtenants 215 may share a single DMS 110 and/or a single data management cluster without unauthorized access by any tenant 210 or subtenant 215 to computing objects or files assigned to a different tenant 210 or subtenant 215. For example, one business unit of an enterprise may not access computing objects or files assigned to a different business unit of the enterprise. As another example, one customer of an MSP may not access computing objects or files assigned to a different customer of the MSP.

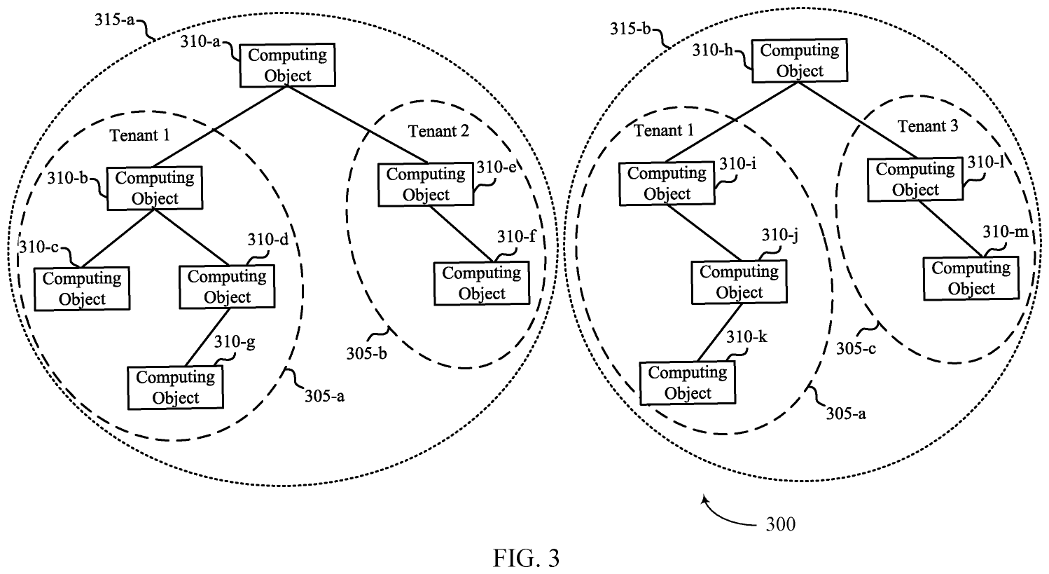

FIG. 3 illustrates an example of a computing object hierarchy 300 that supports multi-tenancy authorization framework for hierarchical resources of a data management system in accordance with aspects of the present disclosure. The computing object hierarchy 300 may implement or be implemented by aspects of the computing environment 100 described with reference to FIG. 1. For example, a DMS 110 may provide backup and recovery protection for data sources for multiple tenants and/or subtenants via one or more data management clusters. For example, FIG. 3 illustrates a first data management cluster 315-a and a second data management cluster 315-b, which may provide protection for data sources associated with a first tenant 305-a, a second tenant 305-b, and a third tenant 305-c.

Each of the first data management cluster 315-a and the second data management cluster 315-b may include a set of computing objects (e.g., resources such as virtual machines or databases) which may be organized according to a hierarchical relationship. For example, the first data management cluster 315-a may include the computing object 310-a, which has as descendants the computing object 310-b and the computing object 310-e. The computing object 310-b has as descendants the computing object 310-c and the computing object 310-d, and the computing object 310-d further has as a descendant the computing object 310-g. The computing object 310-e has as a descendent the computing object 310-f.

The second data management cluster 315-b may include the computing object 310-h, which has as descendants the computing object 310-i and the computing object 310-1. The computing object 310-i has as a descendant the computing object 310-j, and the computing object 310-j further has as a descendant the computing object 310-k. The computing object 310-1 has as a descendent the computing object 310-m.

As described herein, the multiple tenants (the first tenant 305-a, the second tenant 305-b, and the third tenant 305-c) may share data management resources. More specifically, multiple tenants of a DMS 110 may share computing objects 310 of a same data management clusters 315. For example, the first tenant 305-a and the second tenant 305-b may both be assigned computing objects 310 within the first data management cluster 315-a, and the first tenant 305-a and the third tenant 305-c may both be assigned computing objects 310 within the second data management cluster 315-b. The assignment of computing objects 310 of the data management clusters 315 may respect the hierarchical relationship among the computing objects 310. For example, assignment of a top-level computing object such as the computing object 310-b to the first tenant 305-a may result in assignment of (e.g., an implicit assignment of) the computing object 310-c, the computing object 310-d, and the computing object 310-g to the first tenant 305-a, as the computing object 310-c, the computing object 310-d, and the computing object 310-g are descendants of the computing object 310-b within the computing object hierarchy of the first data management cluster 315-a. Similarly, assignment of the computing object 310-e to the second tenant 305-b may result in assignment of the computing object 310-f to the second tenant 305-b. As another example, assignment of the computing object 310-i to the first tenant 305-a may result in assignment of the computing object 310-j and the computing object 310-k to the first tenant 305-a. As another example, assignment of the computing object 310-1 to the third tenant 305-c may result in assignment of the computing object 310-m to the third tenant 305-c. Such implicit assignment of resources based on the computing object hierarchy may simplify management of the DMS 110 for an administrator (e.g., an IT services unit or an MSP). For example, an MSP may assign a full data management cluster 315 to a tenant to achieve assignment of all backup computing objects from that data management cluster 315 to the tenant. As another example, an MSP may assign a Vcenter from a data management cluster 315 to assign all of the virtual machines from that Vcenter to the tenant.

As described herein, the DMS 110 may provide for a multi-tenancy RBAC scheme such that users associated with each tenant/subtenant may access only the computing objects assigned to the given tenant/subtenant. Multi-tenancy RBAC supports in-depth computing object level access control granularity for data management systems such as the DMS 110 with multiple data management clusters. Multi-tenancy RBAC supports both authorizing a full data management cluster 315 to a tenant (e.g., assigning all of the computing objects 310 of a given data management cluster 315 to a given tenant), and assignment of specific computing objects 310 of a data management cluster 315 to a given tenant. A user associated with the first tenant 305-a may not access computing objects assigned to the second tenant 305-b or the third tenant 305-c, a user associated with the second tenant 305-b may not access computing objects assigned to the first tenant 305-a or the third tenant 305-c, and a user associated with the third tenant 305-c may not access computing objects assigned to the first tenant 305-a or the second tenant 305-b. For example, a tenant dashboard (e.g., a user interface view for a tenant account at a computing device 115) may show relevant statistics and information regarding authorized computing objects 310 for that tenant, and the tenant may only manage data backup for the authorized computing objects 310. The multi-tenancy RBAC may prevent information leakage across tenants via enforcing access control at all user interfaces, events, audits, reports, etc., for a tenant, such that a tenant is not able to view or access direct or aggregated information about computing objects 310 that are not assigned to that tenant. A tenant may not bypass the access control enforcement in either the control plane or the cluster side via federated login.

As an example, an MSP account with multiple cloud accounts or on-premise data management clusters (e.g., the first data management cluster 315-a may be a first cloud account or on-premise data management cluster of the MSP and the second data management cluster 315-b may be a second cloud account or on-premise data management cluster of the MSP), and the MSP may assign a specific computing object 310 within the multiple cloud accounts or on-premise data management clusters of the MSP to a given tenant (e.g., customer) of the MSP. Further, multi-tenancy RBAC may authorize different permissions (e.g., read-only, read-write) on different computing objects 310. For example, a tenant (e.g., the first tenant 305-a) may have read-only access to a virtual machine (e.g., the computing object 310-c) but read-write access to a MSSQL database (e.g., the computing object 310-d).

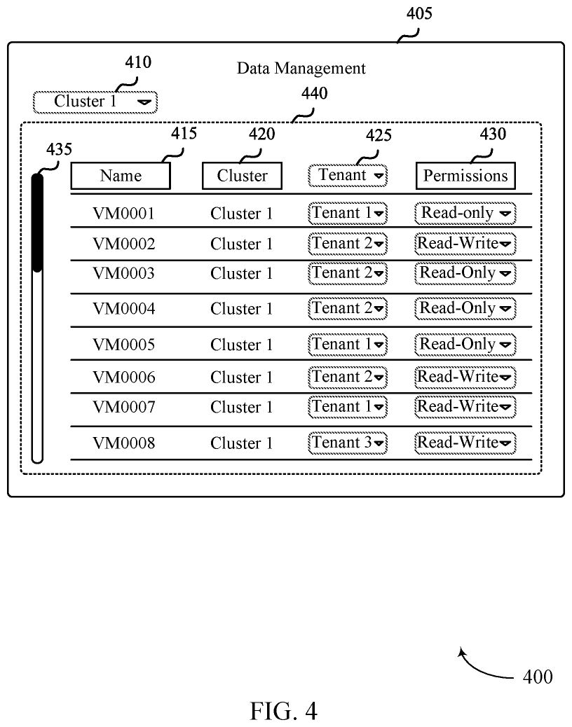

FIG. 4 illustrates an example of a user interface view 400 that supports multi-tenancy authorization framework for hierarchical resources of a data management system in accordance with aspects of the present disclosure. The user interface view 400 may implement or be implemented by aspects of the computing environment 100 described with reference to FIG. 1. For example, the user interface view 400 may be displayed in association with an administrator account for a DMS 110 at a computing device 115 as described with reference to FIG. 1.

The user interface view 400 may include a data management window 405 via which an administrator of the DMS 110 may view and/or assign computing objects, such as virtual machines, to tenants, and/or the via which the administrator of the DMS 110 may view and/or assign permissions for the tenants for the computing objects. An interactable element 410, such as dropdown list, may be used to select a particular data management cluster associated with the DMS 110 (e.g., the first data management cluster 315-a or the second data management cluster 315-b of FIG. 3).

A table 440 may include a first column 415 showing names of computing objects within the cluster, a second column 420 showing the cluster in which each computing object is stored, a third column 425 showing the tenant to which each computing object is assigned, and a fourth column 430 showing the permissions for the tenant for the given computing resource. A scroll bar 435 may enable a user to scroll through the computing objects listed in the table 440. In some examples, a user may sort or filter the results shown within the table 440 by selecting an interactable object at the top of a given column. For example, the information shown in the table 440 may be sorted by computing object name (e.g., VM001, VM002, VM003, etc.) by selecting the interactable object at the top of a first column 415. As another example, the interactable element at the top of the third column 425 may be a drop down list via which the user may select a given tenant or tenants, and accordingly view the computing objects assigned to that tenant or tenants. The items in each row of the third column 425 may include a drop down via which the user may assign a tenant to the given computing object. For example, the user may reassign VM001 from the first tenant to the second tenant. As described herein, computing objects within a data management cluster may have an object hierarchy, and assignment of a given object to a given tenant may result in the automatic assignment of the descendant objects for that given object to the given tenant. Additionally, or alternatively, the items in each row of the fourth column 430 may include a drop down via which the user may select permissions for the tenant for the given computing object. For example, the user may give read-only permissions for some computing objects to a tenant and read-write permissions for other computing objects to the tenant. Accordingly, an administrator for the DMS 110 may provide a set of permissions for a tenant for configuring resources of the DMS 110.

In some examples, as described herein, an administrator may assign, via the user interface view 400, an entire data management cluster to a given tenant. In some examples, as described herein, an administrator may assign permissions to a tenant on a data management cluster basis (e.g., for an entire data management cluster). In some examples, as described herein, an administrator may assign, via the user interface view 400, permissions to a tenant based on an object type (e.g., virtual machines versus databases).

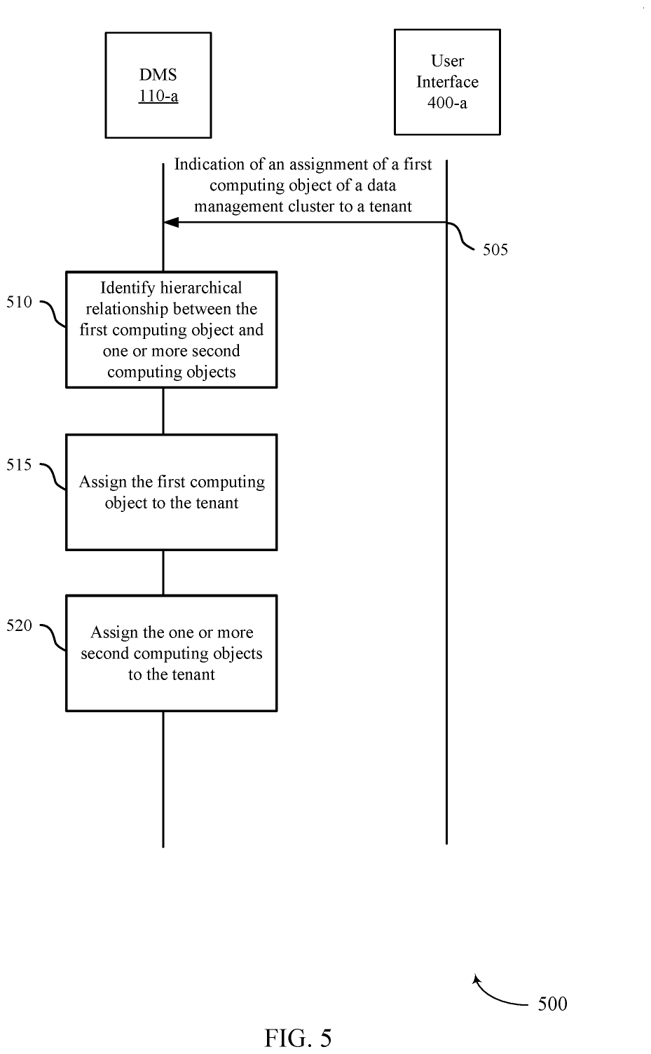

FIG. 5 illustrates an example of a process flow 500 that supports multi-tenancy authorization framework for hierarchical resources of a data management system in accordance with aspects of the present disclosure. The process flow 500 may include a DMS 110-a, which may be an example of a DMS 110 as described herein. The process flow 500 may include a user interface view 400-a, which may be an example of a user interface view 400 as described herein. In the following description of the process flow 500, the operations between the DMS 110-a and the user interface view 400-a may be transmitted in a different order than the example order shown, or the operations performed by the DMS 110-a and the user interface view 400-a may be performed in different orders or at different times. Some operations may also be omitted from the process flow 500, and other operations may be added to the process flow 500.

At 505, the DMS 110-a, may receive an indication of an assignment of a first computing object of a data management cluster to a tenant of the DMS 110-a, where the data management cluster is operable to provide protection for data sources associated with one or more tenants of the DMS 110-a. In some examples, the DMS 110-a may receive the indication of the assignment of a first computing object to the tenant from the user interface view 400-a, which may be associated with an administrator account (e.g., an MSP or an IT services unit of an enterprise).

At 510, the DMS 110-a may identify, in response to the indication of the assignment of the first computing object to the tenant, a hierarchical relationship between the first computing object and one or more second computing objects, where the hierarchical relationship includes the one or more second computing objects being lower within an object hierarchy than the first computing object.

At 515, the DMS 110-a may assign, in response to the indication of the assignment of the first computing object to the tenant, the first computing object to the tenant.

At 520, the DMS 110-a may assign, in response to the indication of the assignment of the first computing object to the tenant, the one or more second computing objects to the tenant based on the one or more second computing objects being lower within the object hierarchy than the first computing object.

In some examples, the DMS 110-a may present, via a second user interface view associated with the tenant, information associated with the first computing object and the one or more second computing objects.

In some examples, the DMS 110-a, may receive an indication of a second assignment of a third computing object of the data management cluster to a second tenant of the DMS 110-a. In some examples, the DMS 110-a may receive the indication of the second assignment from the user interface view 400-a. The DMS 110-a may identify, in response to the indication of the second assignment of the third computing object to the second tenant, a hierarchical relationship between the third computing object and one or more fourth computing objects, where the hierarchical relationship includes the one or more fourth computing objects being lower within a second object hierarchy than the third computing object. The DMS 110-a may assign, in response to the indication of the assignment of the third computing object to the second tenant, the third computing object to the second tenant. The DMS 110-a may assign, in response to the indication of the assignment of the third computing object to the second tenant, the one or more fourth computing objects to the second tenant based on the one or more fourth computing objects being lower within the object hierarchy than the third computing object. In some examples, the DMS 110-a may present, via a second user interface view associated with the second tenant, information associated with the third computing object and the one or more fourth computing objects.

In some examples, the DMS 110-a, may receive an indication of a second assignment of a third computing object of the data management cluster to the tenant of the DMS 110-a. In some examples, the DMS 110-a may receive the indication of the second assignment from the user interface view 400-a. The DMS 110-a may identify, in response to the indication of the second assignment of the third computing object to the tenant, a hierarchical relationship between the third computing object and one or more fourth computing objects, where the hierarchical relationship includes the one or more fourth computing objects being lower within a second object hierarchy than the third computing object. The DMS 110-a may assign, in response to the indication of the assignment of the third computing object to the tenant, the third computing object to the tenant. The DMS 110-a may assign, in response to the indication of the assignment of the third computing object to the tenant, the one or more fourth computing objects to the tenant based on the one or more fourth computing objects being lower within the object hierarchy than the third computing object.

In some examples, the DMS 110-a may receive (e.g., via the user interface view 400-a) an indication of an assignment to the tenant of a first set of permissions for the first computing object and a second set of permissions for at least one computing object of the one or more second computing objects. In some examples, the assignment of the first set of permissions and the second set of permissions is based on the first computing object being a first type of computing object and the at least one computing object of the one or more second computing objects being a second type of computing object. In some examples, the DMS 110-a may receive, from a user interface view associated with the tenant, a request to modify the at least one computing object of the one or more second computing objects, and the DMS 110-a may deny the request to modify the at least one computing object of the one or more second computing objects based on the second set of permissions. For example, the second set of permissions may include a read-only permission for the at least one computing object, and the request to modify the at least one computing object may be denied based on the read-only permission. In some examples, the DMS 110-a may receive, from a user interface view associated with the tenant, a request to modify the at least one computing object of the one or more second computing objects, and the DMS 110-a may modify the at least one computing object of the one or more second computing objects in accordance with the request based on the modifying being allowed by the second set of permissions. For example, the second set of permissions may include a read-write permission for the at least one computing object, and the request to modify the at least one computing object may be allowed based on the read-write permission.

In some examples, the DMS 110-a may receive, from a user interface view associated with a second tenant of the DMS 110-a, a request to access one of the first computing object or the one or more second computing objects, and the DMS 110-a may deny the request to access the one of the first computing object or the one or more second computing objects based on the one of the first computing object or the one or more second computing objects being assigned to the tenant.

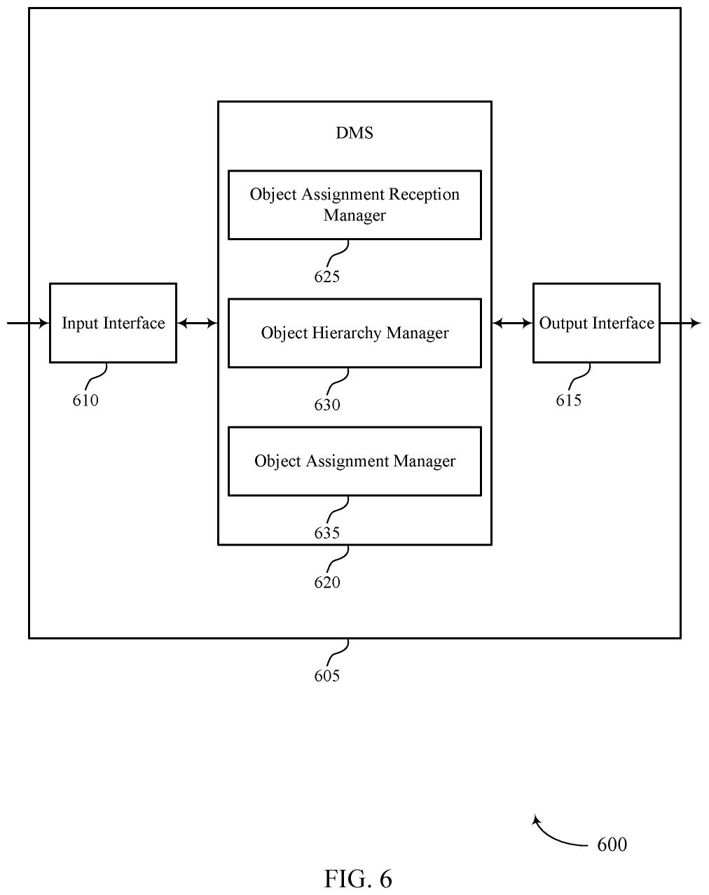

FIG. 6 illustrates a block diagram 600 of a system 605 that supports multi-tenancy authorization framework for hierarchical resources of a data management system in accordance with aspects of the present disclosure. In some examples, the system 605 may be an example of aspects of one or more components described with reference to FIG. 1, such as a DMS 110. The system 605 may include an input interface 610, an output interface 615, and a DMS 620 (e.g., a DMS 110). The system 605 may also include one or more processors. Each of these components may be in communication with one another (e.g., via one or more buses, communications links, communications interfaces, or any combination thereof).

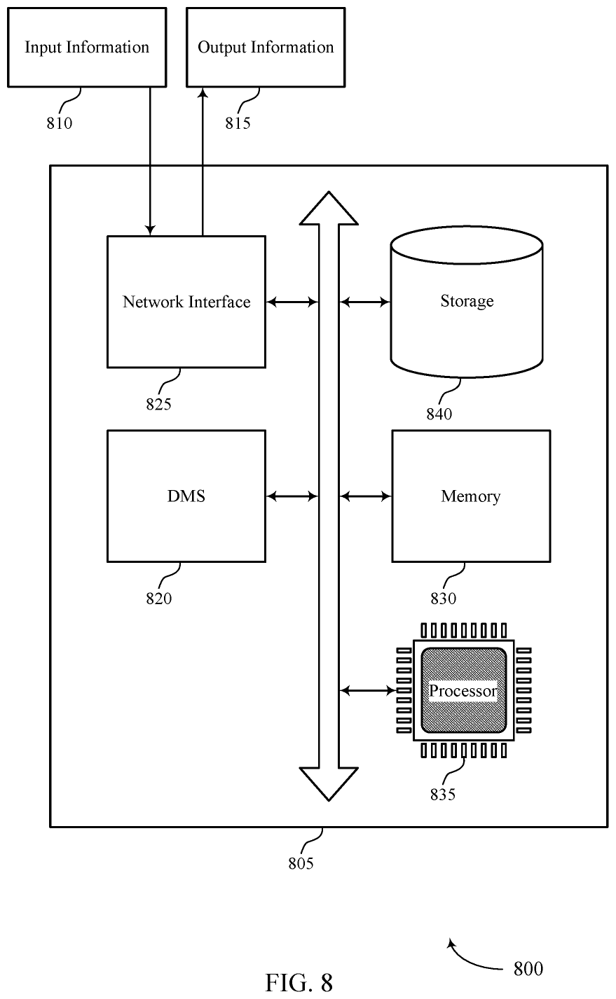

The input interface 610 may manage input signaling for the system 605. For example, the input interface 610 may receive input signaling (e.g., messages, packets, data, instructions, commands, or any other form of encoded information) from other systems or devices. The input interface 610 may send signaling corresponding to (e.g., representative of or otherwise based on) such input signaling to other components of the system 605 for processing. For example, the input interface 610 may transmit such corresponding signaling to the DMS 620 to support multi-tenancy authorization framework for hierarchical resources of a data management system. In some cases, the input interface 610 may be a component of a network interface 825 as described with reference to FIG. 8.

The output interface 615 may manage output signaling for the system 605. For example, the output interface 615 may receive signaling from other components of the system 605, such as the DMS 620, and may transmit such output signaling corresponding to (e.g., representative of or otherwise based on) such signaling to other systems or devices. In some cases, the output interface 615 may be a component of a network interface 825 as described with reference to FIG. 8.

For example, the DMS 620 may include an object assignment reception manager 625, an object hierarchy manager 630, an object assignment manager 635, or any combination thereof. In some examples, the DMS 620, or various components thereof, may be configured to perform various operations (e.g., receiving, monitoring, transmitting) using or otherwise in cooperation with the input interface 610, the output interface 615, or both. For example, the DMS 620 may receive information from the input interface 610, send information to the output interface 615, or be integrated in combination with the input interface 610, the output interface 615, or both to receive information, transmit information, or perform various other operations as described herein.

The object assignment reception manager 625 may be configured as or otherwise support a means for receiving, by a data management system, an indication of an assignment of a first computing object of a data management cluster to a tenant of the data management system, where the data management cluster is operable to provide protection for data sources associated with one or more tenants of the data management system. The object hierarchy manager 630 may be configured as or otherwise support a means for identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object. The object assignment manager 635 may be configured as or otherwise support a means for assigning, by the data management system in response to the indication of the assignment of the first computing object to the tenant, the first computing object to the tenant. The object assignment manager 635 may be configured as or otherwise support a means for assigning, by the data management system in response to the indication of the assignment of the first computing object to the tenant, the one or more second computing objects to the tenant based on the one or more second computing objects being lower within the object hierarchy than the first computing object.

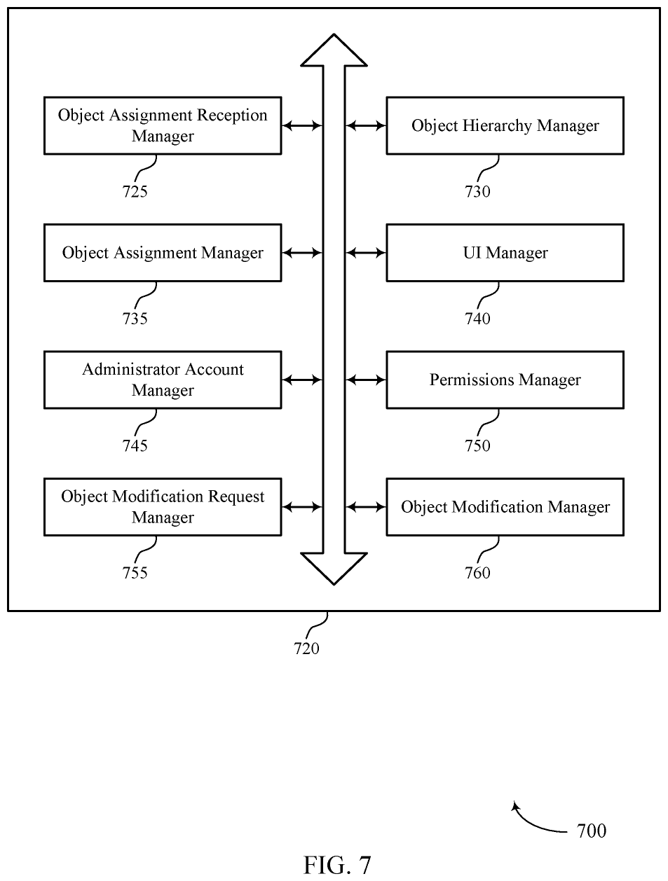

FIG. 7 illustrates a block diagram 700 of a DMS 720 that supports multi-tenancy authorization framework for hierarchical resources of a data management system in accordance with aspects of the present disclosure. The DMS 720 may be an example of aspects of a DMS 620 as described herein. The DMS 720, or various components thereof, may be an example of means for performing various aspects of multi-tenancy authorization framework for hierarchical resources of a data management system as described herein. For example, the DMS 720 may include an object assignment reception manager 725, an object hierarchy manager 730, an object assignment manager 735, a UI manager 740, an administrator account manager 745, a permissions manager 750, an object modification request manager 755, an object modification manager 760, or any combination thereof. Each of these components may communicate, directly or indirectly, with one another (e.g., via one or more buses, communications links, communications interfaces, or any combination thereof).

The object assignment reception manager 725 may be configured as or otherwise support a means for receiving, by a data management system, an indication of an assignment of a first computing object of a data management cluster to a tenant of the data management system, where the data management cluster is operable to provide protection for data sources associated with one or more tenants of the data management system. The object hierarchy manager 730 may be configured as or otherwise support a means for identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object. The object assignment manager 735 may be configured as or otherwise support a means for assigning, by the data management system in response to the indication of the assignment of the first computing object to the tenant, the first computing object to the tenant. In some examples, the object assignment manager 735 may be configured as or otherwise support a means for assigning, by the data management system in response to the indication of the assignment of the first computing object to the tenant, the one or more second computing objects to the tenant based on the one or more second computing objects being lower within the object hierarchy than the first computing object.

In some examples, the UI manager 740 may be configured as or otherwise support a means for presenting, within a user interface view associated with the tenant, information associated with the first computing object and the one or more second computing objects.

In some examples, the object assignment reception manager 725 may be configured as or otherwise support a means for receiving, by the data management system, an indication of a second assignment of a third computing object of the data management cluster to a second tenant of the data management system. In some examples, the object hierarchy manager 730 may be configured as or otherwise support a means for identifying, by the data management system in response to the indication of the second assignment of the third computing object to the second tenant, a hierarchical relationship between the third computing object and one or more fourth computing objects, where the hierarchical relationship includes the one or more fourth computing objects being lower within a second object hierarchy than the third computing object. In some examples, the object assignment manager 735 may be configured as or otherwise support a means for assigning, by the data management system in response to the indication of the assignment of the third computing object to the second tenant, the third computing object to the second tenant. In some examples, the object assignment manager 735 may be configured as or otherwise support a means for assigning, by the data management system in response to the indication of the assignment of the third computing object to the second tenant, the one or more fourth computing objects to the second tenant based on the one or more fourth computing objects being lower within the object hierarchy than the third computing object.

In some examples, the UI manager 740 may be configured as or otherwise support a means for presenting, within a user interface view associated with the second tenant, information associated with the third computing object and the one or more fourth computing objects.

In some examples, the object assignment reception manager 725 may be configured as or otherwise support a means for receiving, by the data management system, an indication of a second assignment of a third computing object of the data management cluster to the tenant of the data management system. In some examples, the object hierarchy manager 730 may be configured as or otherwise support a means for identifying, by the data management system in response to the indication of the second assignment of the third computing object to the tenant, a hierarchical relationship between the third computing object and one or more fourth computing objects, where the hierarchical relationship includes the one or more fourth computing objects being lower within a second object hierarchy than the third computing object. In some examples, the object assignment manager 735 may be configured as or otherwise support a means for assigning, by the data management system in response to the indication of the assignment of the third computing object to the tenant, the third computing object to the tenant. In some examples, the object assignment manager 735 may be configured as or otherwise support a means for assigning, by the data management system in response to the indication of the assignment of the third computing object to the tenant, the one or more fourth computing objects to the tenant based on the one or more fourth computing objects being lower within the object hierarchy than the third computing object.

In some examples, to support receiving the indication of the assignment of the first computing object of the data management cluster to the tenant, the administrator account manager 745 may be configured as or otherwise support a means for receiving the indication of assignment of the first computing object of the data management cluster to the tenant via a user interface view associated with an administrator account for the data management cluster.

In some examples, the permissions manager 750 may be configured as or otherwise support a means for receiving, by the data management system, an indication of an assignment to the tenant of a first set of permissions for the first computing object and a second set of permissions for at least one computing object of the one or more second computing objects.

In some examples, the assignment of the first set of permissions and the second set of permissions is based on the first computing object being a first type of computing object and the at least one computing object of the one or more second computing objects being a second type of computing object.

In some examples, the object modification request manager 755 may be configured as or otherwise support a means for receiving, from a user associated with the tenant, a request to modify the at least one computing object of the one or more second computing objects. In some examples, the permissions manager 750 may be configured as or otherwise support a means for denying the request to modify the at least one computing object of the one or more second computing objects based on the second set of permissions. For example, the second set of permissions may include a read-only permission for the at least one computing object, and the request to modify the at least one computing object may be denied based on the read-only permission.

In some examples, the object modification request manager 755 may be configured as or otherwise support a means for receiving, from a user associated with the tenant, a request to modify the at least one computing object of the one or more second computing objects. In some examples, the object modification manager 760 may be configured as or otherwise support a means for modifying the at least one computing object of the one or more second computing objects in accordance with the request based on the modifying being allowed by the second set of permissions. For example, the second set of permissions may include a read-write permission for the at least one computing object, and the request to modify the at least one computing object may be allowed based on the read-write permission.

In some examples, to support receiving the indication of the assignment to the tenant of the first set of permissions for the first computing object and the second set of permissions for the at least one computing object of the one or more second computing objects, the administrator account manager 745 may be configured as or otherwise support a means for receiving the indication of the assignment to the tenant of the first set of permissions for the first computing object and the second set of permissions for the at least one computing object of the one or more second computing objects via a user interface view associated with an administrator account for the data management cluster.

In some examples, the UI manager 740 may be configured as or otherwise support a means for receiving, from a user interface view associated with a second tenant of the data management system, a request to access one of the first computing object or the one or more second computing objects. In some examples, the object assignment manager 735 may be configured as or otherwise support a means for denying the request to access the one of the first computing object or the one or more second computing objects based on the one of the first computing object or the one or more second computing objects being assigned to the tenant.

FIG. 8 illustrates a block diagram 800 of a system 805 that supports multi-tenancy authorization framework for hierarchical resources of a data management system in accordance with aspects of the present disclosure. The system 805 may be an example of or include the components of a system 605 as described herein. The system 805 may include components for data management, including components such as a DMS 820, an input information 810, an output information 815, a network interface 825, a memory 830, a processor 835, and a storage 840. These components may be in electronic communication or otherwise coupled with each other (e.g., operatively, communicatively, functionally, electronically, electrically; via one or more buses, communications links, communications interfaces, or any combination thereof). Additionally, the components of the system 805 may include corresponding physical components or may be implemented as corresponding virtual components (e.g., components of one or more virtual machines). In some examples, the system 805 may be an example of aspects of one or more components described with reference to FIG. 1, such as a DMS 110.

The network interface 825 may enable the system 805 to exchange information (e.g., input information 810, output information 815, or both) with other systems or devices (not shown). For example, the network interface 825 may enable the system 805 to connect to a network (e.g., a network 120 as described herein). The network interface 825 may include one or more wireless network interfaces, one or more wired network interfaces, or any combination thereof. In some examples, the network interface 825 may be an example of may be an example of aspects of one or more components described with reference to FIG. 1, such as one or more network interfaces 165.

Memory 830 may include RAM, ROM, or both. The memory 830 may store computer-readable, computer-executable software including instructions that, when executed, cause the processor 835 to perform various functions described herein. In some cases, the memory 830 may contain, among other things, a basic input/output system (BIOS), which may control basic hardware or software operation such as the interaction with peripheral components or devices. In some cases, the memory 830 may be an example of aspects of one or more components described with reference to FIG. 1, such as one or more memories 175.

The processor 835 may include an intelligent hardware device, (e.g., a general-purpose processor, a DSP, a CPU, a microcontroller, an ASIC, a field programmable gate array (FPGA), a programmable logic device, a discrete gate or transistor logic component, a discrete hardware component, or any combination thereof). The processor 835 may be configured to execute computer-readable instructions stored in a memory 830 to perform various functions (e.g., functions or tasks supporting multi-tenancy authorization framework for hierarchical resources of a data management system). Though a single processor 835 is depicted in the example of FIG. 8, it is to be understood that the system 805 may include any quantity of one or more of processors 835 and that a group of processors 835 may collectively perform one or more functions ascribed herein to a processor, such as the processor 835. In some cases, the processor 835 may be an example of aspects of one or more components described with reference to FIG. 1, such as one or more processors 170.

Storage 840 may be configured to store data that is generated, processed, stored, or otherwise used by the system 805. In some cases, the storage 840 may include one or more HDDs, one or more SDDs, or both. In some examples, the storage 840 may be an example of a single database, a distributed database, multiple distributed databases, a data store, a data lake, or an emergency backup database. In some examples, the storage 840 may be an example of one or more components described with reference to FIG. 1, such as one or more network disks 180.

For example, the DMS 820 may be configured as or otherwise support a means for receiving, by a data management system, an indication of an assignment of a first computing object of a data management cluster to a tenant of the data management system, where the data management cluster is operable to provide protection for data sources associated with one or more tenants of the data management system. The DMS 820 may be configured as or otherwise support a means for identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object. The DMS 820 may be configured as or otherwise support a means for assigning, by the data management system in response to the indication of the assignment of the first computing object to the tenant, the first computing object to the tenant. The DMS 820 may be configured as or otherwise support a means for assigning, by the data management system in response to the indication of the assignment of the first computing object to the tenant, the one or more second computing objects to the tenant based on the one or more second computing objects being lower within the object hierarchy than the first computing object.

By including or configuring the DMS 820 in accordance with examples as described herein, the system 805 may support techniques for multi-tenancy authorization framework for hierarchical resources of a data management system, which may provide one or more benefits such as, for example, improved reliability, more efficient utilization of computing resources, network resources or both, improved scalability, or improved security, among other possibilities.

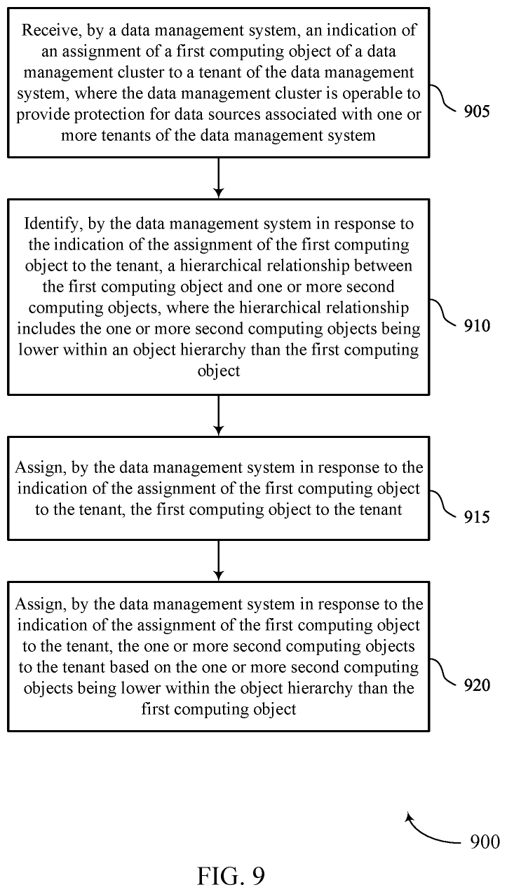

FIG. 9 illustrates a flowchart showing a method 900 that supports multi-tenancy authorization framework for hierarchical resources of a data management system in accordance with aspects of the present disclosure. The operations of the method 900 may be implemented by a DMS or its components as described herein. For example, the operations of the method 900 may be performed by a DMS as described with reference to FIGS. FIG. 1 through 8. In some examples, a DMS may execute a set of instructions to control the functional elements of the DMS to perform the described functions. Additionally, or alternatively, the DMS may perform aspects of the described functions using special-purpose hardware.

At 905, the method may include receiving, by a data management system, an indication of an assignment of a first computing object of a data management cluster to a tenant of the data management system, where the data management cluster is operable to provide protection for data sources associated with one or more tenants of the data management system. The operations of 905 may be performed in accordance with examples as disclosed herein. In some examples, aspects of the operations of 905 may be performed by an object assignment reception manager 725 as described with reference to FIG. 7.

At 910, the method may include identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object. The operations of 910 may be performed in accordance with examples as disclosed herein. In some examples, aspects of the operations of 910 may be performed by an object hierarchy manager 730 as described with reference to FIG. 7.

At 915, the method may include assigning, by the data management system in response to the indication of the assignment of the first computing object to the tenant, the first computing object to the tenant. The operations of 915 may be performed in accordance with examples as disclosed herein. In some examples, aspects of the operations of 915 may be performed by an object assignment manager 735 as described with reference to FIG. 7.

At 920, the method may include assigning, by the data management system in response to the indication of the assignment of the first computing object to the tenant, the one or more second computing objects to the tenant based on the one or more second computing objects being lower within the object hierarchy than the first computing object. The operations of 920 may be performed in accordance with examples as disclosed herein. In some examples, aspects of the operations of 920 may be performed by an object assignment manager 735 as described with reference to FIG. 7.

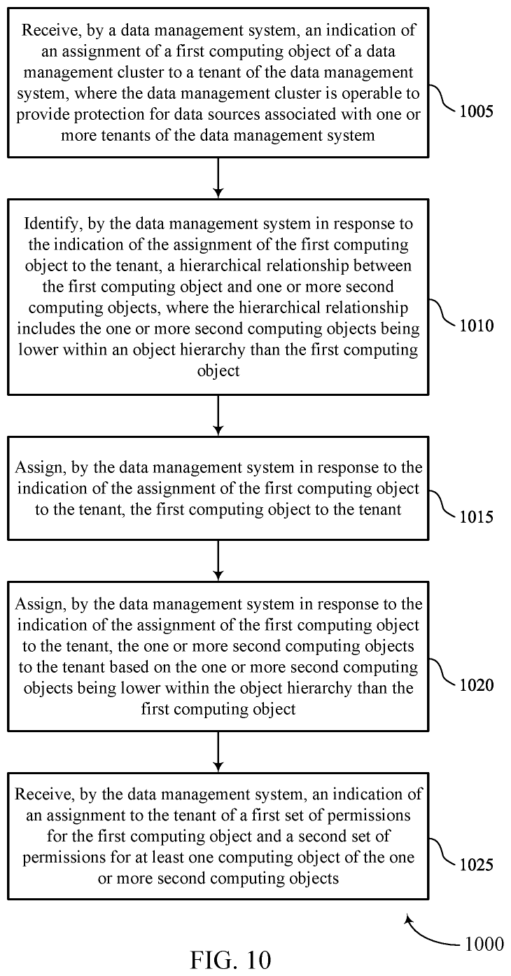

FIG. 10 illustrates a flowchart showing a method 1000 that supports multi-tenancy authorization framework for hierarchical resources of a data management system in accordance with aspects of the present disclosure. The operations of the method 1000 may be implemented by a DMS or its components as described herein. For example, the operations of the method 1000 may be performed by a DMS as described with reference to FIGS. FIG. 1 through 8. In some examples, a DMS may execute a set of instructions to control the functional elements of the DMS to perform the described functions. Additionally, or alternatively, the DMS may perform aspects of the described functions using special-purpose hardware.

At 1005, the method may include receiving, by a data management system, an indication of an assignment of a first computing object of a data management cluster to a tenant of the data management system, where the data management cluster is operable to provide protection for data sources associated with one or more tenants of the data management system. The operations of 1005 may be performed in accordance with examples as disclosed herein. In some examples, aspects of the operations of 1005 may be performed by an object assignment reception manager 725 as described with reference to FIG. 7.

At 1010, the method may include identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object. The operations of 1010 may be performed in accordance with examples as disclosed herein. In some examples, aspects of the operations of 1010 may be performed by an object hierarchy manager 730 as described with reference to FIG. 7.

At 1015, the method may include assigning, by the data management system in response to the indication of the assignment of the first computing object to the tenant, the first computing object to the tenant. The operations of 1015 may be performed in accordance with examples as disclosed herein. In some examples, aspects of the operations of 1015 may be performed by an object assignment manager 735 as described with reference to FIG. 7.

At 1020, the method may include assigning, by the data management system in response to the indication of the assignment of the first computing object to the tenant, the one or more second computing objects to the tenant based on the one or more second computing objects being lower within the object hierarchy than the first computing object. The operations of 1020 may be performed in accordance with examples as disclosed herein. In some examples, aspects of the operations of 1020 may be performed by an object assignment manager 735 as described with reference to FIG. 7.

At 1025, the method may include receiving, by the data management system, an indication of an assignment to the tenant of a first set of permissions for the first computing object and a second set of permissions for at least one computing object of the one or more second computing objects. The operations of 1025 may be performed in accordance with examples as disclosed herein. In some examples, aspects of the operations of 1025 may be performed by a permissions manager 750 as described with reference to FIG. 7.

A method is described. The method may include receiving, by a data management system, an indication of an assignment of a first computing object of a data management cluster to a tenant of the data management system, where the data management cluster is operable to provide protection for data sources associated with one or more tenants of the data management system, identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object, assigning, by the data management system in response to the indication of the assignment of the first computing object to the tenant, the first computing object to the tenant, and assigning, by the data management system in response to the indication of the assignment of the first computing object to the tenant, the one or more second computing objects to the tenant based on the one or more second computing objects being lower within the object hierarchy than the first computing object.

An apparatus is described. The apparatus may include a processor, memory coupled with the processor, and instructions stored in the memory. The instructions may be executable by the processor to cause the apparatus to receive, by a data management system, an indication of an assignment of a first computing object of a data management cluster to a tenant of the data management system, where the data management cluster is operable to provide protection for data sources associated with one or more tenants of the data management system, identify, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object, assign, by the data management system in response to the indication of the assignment of the first computing object to the tenant, the first computing object to the tenant, and assign, by the data management system in response to the indication of the assignment of the first computing object to the tenant, the one or more second computing objects to the tenant based on the one or more second computing objects being lower within the object hierarchy than the first computing object.

Another apparatus is described. The apparatus may include means for receiving, by a data management system, an indication of an assignment of a first computing object of a data management cluster to a tenant of the data management system, where the data management cluster is operable to provide protection for data sources associated with one or more tenants of the data management system, means for identifying, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object, means for assigning, by the data management system in response to the indication of the assignment of the first computing object to the tenant, the first computing object to the tenant, and means for assigning, by the data management system in response to the indication of the assignment of the first computing object to the tenant, the one or more second computing objects to the tenant based on the one or more second computing objects being lower within the object hierarchy than the first computing object.

A non-transitory computer-readable medium storing code is described. The code may include instructions executable by a processor to receive, by a data management system, an indication of an assignment of a first computing object of a data management cluster to a tenant of the data management system, where the data management cluster is operable to provide protection for data sources associated with one or more tenants of the data management system, identify, by the data management system in response to the indication of the assignment of the first computing object to the tenant, a hierarchical relationship between the first computing object and one or more second computing objects, where the hierarchical relationship includes the one or more second computing objects being lower within an object hierarchy than the first computing object, assign, by the data management system in response to the indication of the assignment of the first computing object to the tenant, the first computing object to the tenant, and assign, by the data management system in response to the indication of the assignment of the first computing object to the tenant, the one or more second computing objects to the tenant based on the one or more second computing objects being lower within the object hierarchy than the first computing object.

Some examples of the method, apparatuses, and non-transitory computer-readable medium described herein may further include operations, features, means, or instructions for presenting, within a user interface view associated with the tenant, information associated with the first computing object and the one or more second computing objects.

Some examples of the method, apparatuses, and non-transitory computer-readable medium described herein may further include operations, features, means, or instructions for receiving, by the data management system, an indication of a second assignment of a third computing object of the data management cluster to a second tenant of the data management system, identifying, by the data management system in response to the indication of the second assignment of the third computing object to the second tenant, a hierarchical relationship between the third computing object and one or more fourth computing objects, where the hierarchical relationship includes the one or more fourth computing objects being lower within a second object hierarchy than the third computing object, assigning, by the data management system in response to the indication of the assignment of the third computing object to the second tenant, the third computing object to the second tenant, and assigning, by the data management system in response to the indication of the assignment of the third computing object to the second tenant, the one or more fourth computing objects to the second tenant based on the one or more fourth computing objects being lower within the object hierarchy than the third computing object.

Some examples of the method, apparatuses, and non-transitory computer-readable medium described herein may further include operations, features, means, or instructions for presenting, within a user interface view associated with the second tenant, information associated with the third computing object and the one or more fourth computing objects.

Some examples of the method, apparatuses, and non-transitory computer-readable medium described herein may further include operations, features, means, or instructions for receiving, by the data management system, an indication of a second assignment of a third computing object of the data management cluster to the tenant of the data management system, identifying, by the data management system in response to the indication of the second assignment of the third computing object to the tenant, a hierarchical relationship between the third computing object and one or more fourth computing objects, where the hierarchical relationship includes the one or more fourth computing objects being lower within a second object hierarchy than the third computing object, assigning, by the data management system in response to the indication of the assignment of the third computing object to the tenant, the third computing object to the tenant, and assigning, by the data management system in response to the indication of the assignment of the third computing object to the tenant, the one or more fourth computing objects to the tenant based on the one or more fourth computing objects being lower within the object hierarchy than the third computing object.

In some examples of the method, apparatuses, and non-transitory computer-readable medium described herein, receiving the indication of the assignment of the first computing object of the data management cluster to the tenant may include operations, features, means, or instructions for receiving the indication of assignment of the first computing object of the data management cluster to the tenant via a user interface view associated with an administrator account for the data management cluster.

Some examples of the method, apparatuses, and non-transitory computer-readable medium described herein may further include operations, features, means, or instructions for receiving, by the data management system, an indication of an assignment to the tenant of a first set of permissions for the first computing object and a second set of permissions for at least one computing object of the one or more second computing objects.

In some examples of the method, apparatuses, and non-transitory computer-readable medium described herein, the assignment of the first set of permissions and the second set of permissions may be based on the first computing object being a first type of computing object and the at least one computing object of the one or more second computing objects being a second type of computing object.

Some examples of the method, apparatuses, and non-transitory computer-readable medium described herein may further include operations, features, means, or instructions for receiving, from a user associated with the tenant, a request to modify the at least one computing object of the one or more second computing objects, and denying the request to modify the at least one computing object of the one or more second computing objects based on the second set of permissions. For example, the second set of permissions may include a read-only permission for the at least one computing object, and the request to modify the at least one computing object may be denied based on the read-only permission.

Some examples of the method, apparatuses, and non-transitory computer-readable medium described herein may further include operations, features, means, or instructions for receiving, from a user associated with the tenant, a request to modify the at least one computing object of the one or more second computing objects, and modifying the at least one computing object of the one or more second computing objects in accordance with the request based on the modifying being allowed by the second set of permissions. For example, the second set of permissions may include a read-write permission for the at least one computing object, and the request to modify the at least one computing object may be allowed based on the read-write permission.

In some examples of the method, apparatuses, and non-transitory computer-readable medium described herein, receiving the indication of the assignment to the tenant of the first set of permissions for the first computing object and the second set of permissions for the at least one computing object of the one or more second computing objects may include operations, features, means, or instructions for receiving the indication of the assignment to the tenant of the first set of permissions for the first computing object and the second set of permissions for the at least one computing object of the one or more second computing objects via a user interface view associated with an administrator account for the data management cluster.

Some examples of the method, apparatuses, and non-transitory computer-readable medium described herein may further include operations, features, means, or instructions for receiving, from a user interface view associated with a second tenant of the data management system, a request to access one of the first computing object or the one or more second computing objects and denying the request to access the one of the first computing object or the one or more second computing objects based on the one of the first computing object or the one or more second computing objects being assigned to the tenant.

It should be noted that the methods described above describe possible implementations, and that the operations and the steps may be rearranged or otherwise modified and that other implementations are possible. Furthermore, aspects from two or more of the methods may be combined.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Further, a system as used herein may be a collection of devices, a single device, or aspects within a single device.

Also, as used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media can comprise RAM, ROM, EEPROM) compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method, comprising:
receiving, by a data management system, an indication of an assignment of a first computing object of a data management cluster to a tenant of the data management system, wherein the data management cluster is operable to provide protection for data sources associated with one or more tenants of the data management system;
identifying, by the data management system in response to the indication of the assignment of the first computing object to the tenant, a hierarchical relationship between the first computing object and one or more second computing objects, wherein the hierarchical relationship comprises the one or more second computing objects being lower within an object hierarchy than the first computing object;
assigning, by the data management system in response to the indication of the assignment of the first computing object to the tenant, the first computing object to the tenant; and
assigning, by the data management system in response to the indication of the assignment of the first computing object to the tenant, the one or more second computing objects to the tenant based at least in part on the one or more second computing objects being lower within the object hierarchy than the first computing object.

2. The method of claim 1, further comprising:
presenting, within a user interface view associated with the tenant, information associated with the first computing object and the one or more second computing objects.

3. The method of claim 1, further comprising:
receiving, by the data management system, an indication of a second assignment of a third computing object of the data management cluster to a second tenant of the data management system;
identifying, by the data management system in response to the indication of the second assignment of the third computing object to the second tenant, a hierarchical relationship between the third computing object and one or more fourth computing objects, wherein the hierarchical relationship comprises the one or more fourth computing objects being lower within a second object hierarchy than the third computing object;
assigning, by the data management system in response to the indication of the assignment of the third computing object to the second tenant, the third computing object to the second tenant; and
assigning, by the data management system in response to the indication of the assignment of the third computing object to the second tenant, the one or more fourth computing objects to the second tenant based at least in part on the one or more fourth computing objects being lower within the object hierarchy than the third computing object.

4. The method of claim 3, further comprising:
presenting, within a user interface view associated with the second tenant, information associated with the third computing object and the one or more fourth computing objects.

5. The method of claim 1, further comprising:
receiving, by the data management system, an indication of a second assignment of a third computing object of the data management cluster to the tenant of the data management system;
identifying, by the data management system in response to the indication of the second assignment of the third computing object to the tenant, a hierarchical relationship between the third computing object and one or more fourth computing objects, wherein the hierarchical relationship comprises the one or more fourth computing objects being lower within a second object hierarchy than the third computing object;
assigning, by the data management system in response to the indication of the assignment of the third computing object to the tenant, the third computing object to the tenant; and
assigning, by the data management system in response to the indication of the assignment of the third computing object to the tenant, the one or more fourth computing objects to the tenant based at least in part on the one or more fourth computing objects being lower within the object hierarchy than the third computing object.

6. The method of claim 1, wherein receiving the indication of the assignment of the first computing object of the data management cluster to the tenant comprises:
receiving the indication of assignment of the first computing object of the data management cluster to the tenant via a user interface view associated with an administrator account for the data management cluster.

7. The method of claim 1, further comprising:
receiving, by the data management system, an indication of an assignment to the tenant of a first set of permissions for the first computing object and a second set of permissions for at least one computing object of the one or more second computing objects.

8. The method of claim 7, wherein the assignment of the first set of permissions and the second set of permissions is based at least in part on the first computing object being a first type of computing object and the at least one computing object of the one or more second computing objects being a second type of computing object.

9. The method of claim 7, further comprising:
receiving, from a user associated with the tenant, a request to modify the at least one computing object of the one or more second computing objects; and
denying the request to modify the at least one computing object of the one or more second computing objects based at least in part on the second set of permissions.

10. The method of claim 7, further comprising:
receiving, from a user associated with the tenant, a request to modify the at least one computing object of the one or more second computing objects; and
modifying the at least one computing object of the one or more second computing objects in accordance with the request based at least in part on the modifying being allowed by the second set of permissions.

11. The method of claim 7, wherein receiving the indication of the assignment to the tenant of the first set of permissions for the first computing object and the second set of permissions for the at least one computing object of the one or more second computing objects comprises:
receiving the indication of the assignment to the tenant of the first set of permissions for the first computing object and the second set of permissions for the at least one computing object of the one or more second computing objects via a user interface view associated with an administrator account for the data management cluster.

12. The method of claim 1, further comprising:
receiving, from a user interface view associated with a second tenant of the data management system, a request to access one of the first computing object or the one or more second computing objects; and
denying the request to access the one of the first computing object or the one or more second computing objects based at least in part on the one of the first computing object or the one or more second computing objects being assigned to the tenant.

13. An apparatus, comprising:
a processor;
memory coupled with the processor; and
instructions stored in the memory and executable by the processor to cause the apparatus to:
receive, by a data management system, an indication of an assignment of a first computing object of a data management cluster to a tenant of the data management system, wherein the data management cluster is operable to provide protection for data sources associated with one or more tenants of the data management system;
identify, by the data management system in response to the indication of the assignment of the first computing object to the tenant, a hierarchical relationship between the first computing object and one or more second computing objects, wherein the hierarchical relationship comprises the one or more second computing objects being lower within an object hierarchy than the first computing object;
assign, by the data management system in response to the indication of the assignment of the first computing object to the tenant, the first computing object to the tenant; and
assign, by the data management system in response to the indication of the assignment of the first computing object to the tenant, the one or more second computing objects to the tenant based at least in part on the one or more second computing objects being lower within the object hierarchy than the first computing object.

14. The apparatus of claim 13, wherein the instructions are further executable by the processor to cause the apparatus to:
present, within a user interface view associated with the tenant, information associated with the first computing object and the one or more second computing objects.

15. The apparatus of claim 13, wherein the instructions are further executable by the processor to cause the apparatus to:
receive, by the data management system, an indication of a second assignment of a third computing object of the data management cluster to a second tenant of the data management system;
identify, by the data management system in response to the indication of the second assignment of the third computing object to the second tenant, a hierarchical relationship between the third computing object and one or more fourth computing objects, wherein the hierarchical relationship comprises the one or more fourth computing objects being lower within a second object hierarchy than the third computing object;
assign, by the data management system in response to the indication of the assignment of the third computing object to the second tenant, the third computing object to the second tenant; and
assign, by the data management system in response to the indication of the assignment of the third computing object to the second tenant, the one or more fourth computing objects to the second tenant based at least in part on the one or more fourth computing objects being lower within the object hierarchy than the third computing object.

16. The apparatus of claim 15, wherein the instructions are further executable by the processor to cause the apparatus to:
present, within a user interface view associated with the second tenant, information associated with the third computing object and the one or more fourth computing objects.

17. The apparatus of claim 13, wherein the instructions are further executable by the processor to cause the apparatus to:
receive, by the data management system, an indication of a second assignment of a third computing object of the data management cluster to the tenant of the data management system;
identify, by the data management system in response to the indication of the second assignment of the third computing object to the tenant, a hierarchical relationship between the third computing object and one or more fourth computing objects, wherein the hierarchical relationship comprises the one or more fourth computing objects being lower within a second object hierarchy than the third computing object;
assign, by the data management system in response to the indication of the assignment of the third computing object to the tenant, the third computing object to the tenant; and
assign, by the data management system in response to the indication of the assignment of the third computing object to the tenant, the one or more fourth computing objects to the tenant based at least in part on the one or more fourth computing objects being lower within the object hierarchy than the third computing object.

18. The apparatus of claim 13, wherein, to receive the indication of the assignment of the first computing object of the data management cluster to the tenant, the instructions are executable by the processor to cause the apparatus to:
receive the indication of assignment of the first computing object of the data management cluster to the tenant via a user interface view associated with an administrator account for the data management cluster.

19. The apparatus of claim 13, wherein the instructions are further executable by the processor to cause the apparatus to:
receive, by the data management system, an indication of an assignment to the tenant of a first set of permissions for the first computing object and a second set of permissions for at least one computing object of the one or more second computing objects.

20. A non-transitory computer-readable medium storing code, the code comprising instructions executable by a processor to:
receive, by a data management system, an indication of an assignment of a first computing object of a data management cluster to a tenant of the data management system, wherein the data management cluster is operable to provide protection for data sources associated with one or more tenants of the data management system;
identify, by the data management system in response to the indication of the assignment of the first computing object to the tenant, a hierarchical relationship between the first computing object and one or more second computing objects, wherein the hierarchical relationship comprises the one or more second computing objects being lower within an object hierarchy than the first computing object;
assign, by the data management system in response to the indication of the assignment of the first computing object to the tenant, the first computing object to the tenant; and
assign, by the data management system in response to the indication of the assignment of the first computing object to the tenant, the one or more second computing objects to the tenant based at least in part on the one or more second computing objects being lower within the object hierarchy than the first computing object.
